(19) United States
(12) Patent Application Publication
(10) Pub. No.: US 2016/0239888 A1
(43) Pub. Date: Aug. 18, 2016

(54) SYSTEMS AND METHODS FOR VERIFYING COMPLIANCE IN AN ELECTRONIC MARKETPLACE

(71) Applicant: David Silver, Zug (CH)

(72) Inventor: David Silver, Zug (CH)

(21) Appl. No.: 15/044,274

(22) Filed: Feb. 16, 2016

Related U.S. Application Data
(60) Provisional application No. 62/115,699, filed on Feb. 13, 2015.

(51) Int. Cl. G06Q 30/06

(52) U.S. Cl. CPC G06Q 30/0609

(57) ABSTRACT

The present disclosure is directed towards systems and methods for evaluating a seller entity in an electronic marketplace offering products related to a brand, owner entity comprising obtaining market information from one or more electronic marketplaces. The market information comprises market listing information, seller information and marketplace information. Market data is derived from one or more of the market listing information, the seller information and the marketplace information and stored in a non-transient memory. The authenticity of the market data is determined in view of the one or more authenticated branded products and behavioral data is updated in response to an authentication of the market data. At least, one reputational score value is generated, wherein said generating comprises combining the behavioral data and the market data. The at least one reputational score value is indicative of the evaluation of the seller entity based on enforcement actions and results from one or more brand owners.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves ail copyright rights whatsoever. The following notice applies to this document: Copyright© 2016 Thomson Reuters.

### TECHNICAL FIELD

This disclosure relates generally to compliance verification in an electronic marketplace. More specifically, the disclosure is directed towards systems and methods for evaluating a seller in an electronic marketplace offering branded products.

### BACKGROUND

With the success of the Internet, electronic marketplaces or e-marketplaces like EBAY®, AMAZON®, ALIBABA.COM®, or TAOBAO® have become increasingly popular with a plethora of products being, offered for sale and sold through those platforms. Often the products are so-called branded products as they refer to or display a trademark or belong to an established brand. The owner of a trademark or brand, also referred to as brand owner, is interested in that only authorized or genuine products are offered and sold but frequently counterfeit and grey market products are offered and sold via electronic marketplaces. Counterfeit products are fake replicas of real products and are often produced, offered and sold with the intent to take advantage of the higher value of the imitated product. Grey market products are parallel imports of products intended to be sold in one country or region and sold in another where they were not intended to be sold. The intent of selling grey market products is to take advantage of the price/margin disparities found in the manufacturer's pricing across countries.

Currently, marketplaces represent a seller's reputation based on generalized seller data and the seller's ability to deliver the goods that they list in their listing as well as their reputation for shipping in an expedient manner. However, there are no capabilities that exist today focused across one or more brands which allow an understanding of the seller as a seller of a particular brand or brands and the aggregation of the enforcement actions, histories, and results from those enforcements by one or more brand owners.

Accordingly, there exists a need for a brand centric reputational view of sellers that span across various brand owners, marketplaces, and enforcements.

### SUMMARY

The present disclosure is directed towards systems and methods for evaluating a seller entity in an electronic marketplace. The seller entity offers products related to a brand owner or brand owner entity. In one aspect, the method includes obtaining, by at least one specialized computer system, market information from one or more electronic marketplaces, the market information comprising market listing information comprising one or more offered branded products, seller information comprising seller entity and activity information, and marketplace information comprising marketplace identification. Market data is derived from one or more of the market listing information, the seller information and the marketplace information and stored in a non-transient memory. The authenticity of the market data is then determined in view of the one or more authenticated branded products and the non-transient memory is updated with behavioral data in response to an authentication of the market data, wherein said behavioral data comprises one or more of brand owner claim information and marketplace determination information. At least one reputational score value is the generated, wherein said generating comprises combining the behavioral data and the market data, wherein said at least one reputational score value is indicative of the evaluation of the seller entity. The at least, one reputational score value is indicative of the evaluation of the seller entity or as to the likelihood of a seller entity being a legitimate or illegitimate seller of brand owner's goods.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for evaluating a seller entity in an electronic marketplace offering branded products;

FIG. 2 is a further schematic depicting an exemplary computer-based system for evaluating a seller entity in an electronic marketplace offering branded products;

FIG. 3 is a flow diagram illustrating an exemplary computer-implemented method for evaluating a seller entity in an electronic marketplace offering branded products;

FIG. 4 is an illustration of brand owner entities initiating search requests of marketplaces and asking for all listings selling branded products;

FIG. 5 illustrates the extraction of listing information from one or more marketplaces;

FIG. 6 is an illustration of collecting additional information by the brand owner entities;

FIG. 7 is an illustration of either acknowledgement or rejection by the marketplaces as to whether a listing is in violation or compliance with the rules, with resulting information used in the creation of behavioral data; and

FIG. 8 is an illustration with an added brand owner entity along with leveraging seller reputational data.

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure,

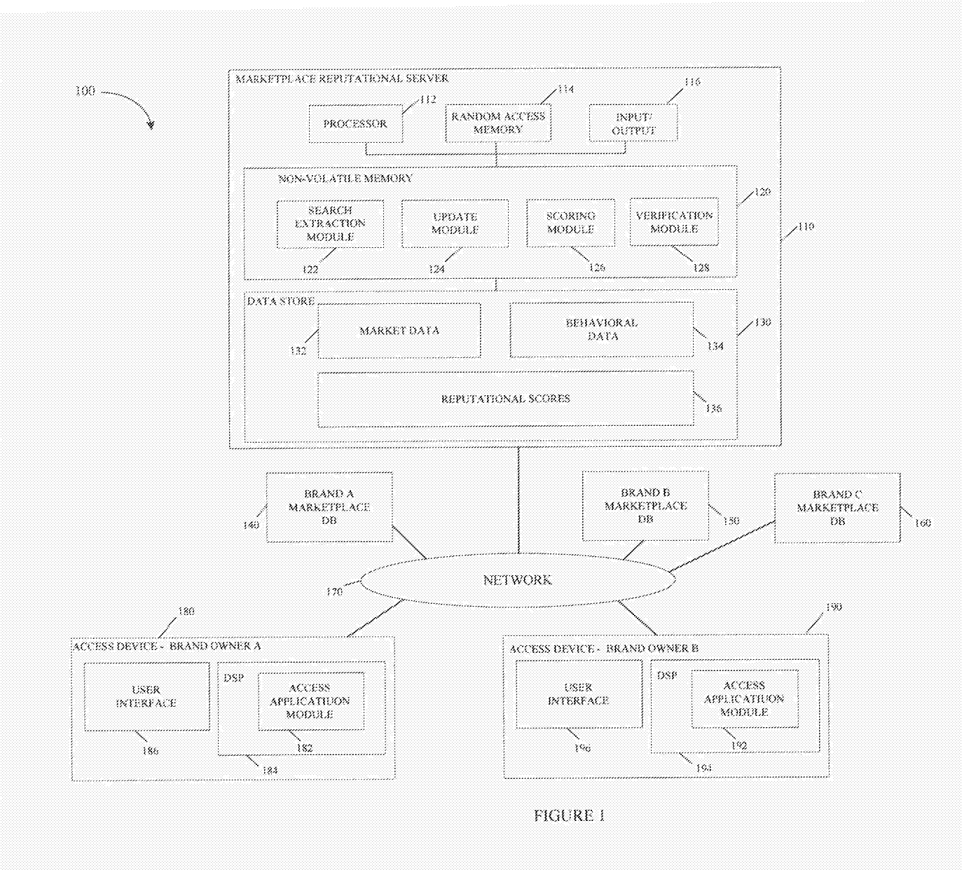

Turning now to FIG. 1, an example of a suitable computing system 100 within which embodiments of the disclosure may he implemented is presented. The computing system 100 is only one example and is not intended to suggest any limitation as to the scope of use or functionality of the disclosure. Neither should the computing system 100 be interpreted, as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that, include any of the above systems or devices, and the like.

The disclosure may be described in the general context of computer-executable instructions, such as program modules, being executed by a computer. Generally, program modules include routines, programs, objects, components, data structures, loop code segments and constructs, and other computer instructions known to those skilled in the art that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which may be written on any form of a computer readable media.

In one embodiment, with reference to FIG. 1, the system 100 includes a server device 110 configured to include a processor 112, such as a central processing unit (“CPU”), random access memory (“RAM”) 114, one or more input-output devices 116, such as a display device (not shown) and keyboard (not shown), non-volatile memory 120 and a data store 130, all of which are interconnected via a common bus and controlled by the processor 112.

As shown in the FIG. 1 example, in one embodiment, the non-volatile memory 120 is configured to include a search and extraction module 122, an update module 124, a scoring module 126, and a verification module 128.

The search and extraction module 122 is used to initiate the retrieval of market information and to derive market data from the obtained market information. The update module 124 is used to process and update the market data and/or behavioral data. The scoring module 126 computes and calculates reputational score values and the verification module 128 supports the review of the market data and/or the subsequent correlation of market data against, the behavioral data to add, update, or delete reputational score values.

As shown in FIG. 1, in one embodiment, a network 170 is provided that can include various, devices such as routers, server, administration devices, and switching elements connected in an Intranet, Extranet or Internet configuration. The network 170 provides access to electronic marketplaces ore-marketplaces (not show in FIG. 1). In one embodiment, the network 170 uses wired communications to transfer information between marketplaces, access devices 180 and 190, brand marketplace databases or brand database servers 140, 150, 160, and the server device 110 with the data store 130. Access device 180 is an access device of for example, brand owner A that has access to the band A marketplace database server 140. Access device 190 is an access device of brand owner B with access to the brand B marketplace database server 150. The brand C marketplace database server 160 is connected to the network 170. A brand owner C access device (not shown) has access to the band C marketplace database 160.

In another embodiment, the network 170 employs wireless communication protocols to transfer information between marketplaces, the access devices 180 and 190, the brand marketplace databases or servers 140, 150, 160, and the server device 110 with the data store 130. For example, the network 170 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 170 may also be a Wide Area Network (WAN), such as the Internet, which employs one or more transmission protocols, e.g. TCP/IP. As another example, the network 170 may employ a combination of digital cellular standards and transmission protocols. In yet other embodiments, the network 170 may employ a combination of wired and wireless technologies to transfer information between the access devices 180 and 190, the brand marketplace databases or servers 140, 150, 160, the data store 130, the server device 110, and the marketplaces.

The data store 130 is a repository that maintains and stores information utilized by the before-mentioned modules 122 to 128. In one embodiment, the data store 130 is a relational database. In another embodiment, the data store 130 is a directory server, such as a Lightweight Directory Access Protocol (“LDAP”). In yet another embodiment, the data store 130 is an area of non-volatile memory 120 of the server device 110.

In one embodiment, as shown in the FIG. 1 example, the data store 130 includes a market data store 132, a behavioral data store 134 and a reputational score data store 136. The market data store 132, according to one embodiment, maintains market data, also referred to as seller-brand data, which is derived from the market listing information comprising one or more offered branded products, the seller information comprising the seller entity and activity information, and the marketplace information comprising marketplace identification. The behavioral data store 134, according to one embodiment, includes brand owner claim information, such as legitimacy determination, date reviewed, brand owners decision, and marketplace determination information, such as listing takedown status, time taken for removal, repeat infringer, additional seller identification, number of times seller requested for removal. The reputational score data store 136 comprises reputational score values including brand owner reputation values, marketplace seller reputation values, and marketplace reputation values

Although the data store 130 shown in FIG. 1 is connected to the network 170, it will be appreciated by one skilled in the art that the data store 130 and/or any of the information shown therein, can be distributed across various servers and be accessible to the server 110 and/or by the access devices 180 and 190 over the network 170; be coupled directly to the server 110; be configured as part of server 110 and interconnected to processor 112, RAM 114, the one or more input-output devices 116 and the non-volatile memory 120 via the common bus; or be configured in an area of non-volatile memory 120 of the server 110.

The access devices 180 and 190, according to one embodiment, are general purpose or special purpose computing devices comprising; a touch-sensitive graphical user interface (“GUI”), GUI 186 and GUI 196, respectively; a digital signal processor (“DSP”), DSP 184 and DSP 194, respectively; each DSP having an access application module that allows a user to access application module 182 and access application module 192, respectively; transient and persistent storage devices such as band marketplace databases 140, 150 and 160; the server 110; an input/output subsystem (not shown); and a bus to provide a communications path between components comprising the general purpose or special purpose computer (not shown). According to one embodiment, access application module 182 and access application module 192 are web-based and use thin client applications (not shown), such as a web browser, which allows a user to access the brand marketplace database 140, 150, and the server 110. Examples of web browsers are known in the art, and include well-known web browsers such as MICROSOFT® INTERNET EXPLORER®, GOOGLE CHROME™, MOZILLA FIREFOX® AND APPLE® SAFARI®. According to another embodiment, access devices 180 and 190, are mobile electronic devices, each having GUI, a DSP having an access application module, internal and external storage components; a power management system; an audio component; audio input/output components: an image capture and process system; RF antenna; and a subscriber identification module (SIM) (not shown). Although system 100 is described generally herein as comprising two separate access devices, access devices 180 and 190, it should be appreciated that the present invention does not require at least two separate access devices, nor is it limited to solely two access devices. Indeed, system 300 can include a single access device, such as access device 180 or access device 190, or multiple access devices.

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a standalone configuration. Data input and requests are communicated to the computing device via various communication channels. Data output of the system is communicated from the computing device to a display device, such as a computer monitor, or other devices. According to one embodiment, data output includes at least one reputational score value or multiple reputational score value such as brand owner reputation values, marketplace seller reputation values, and marketplace reputation values.

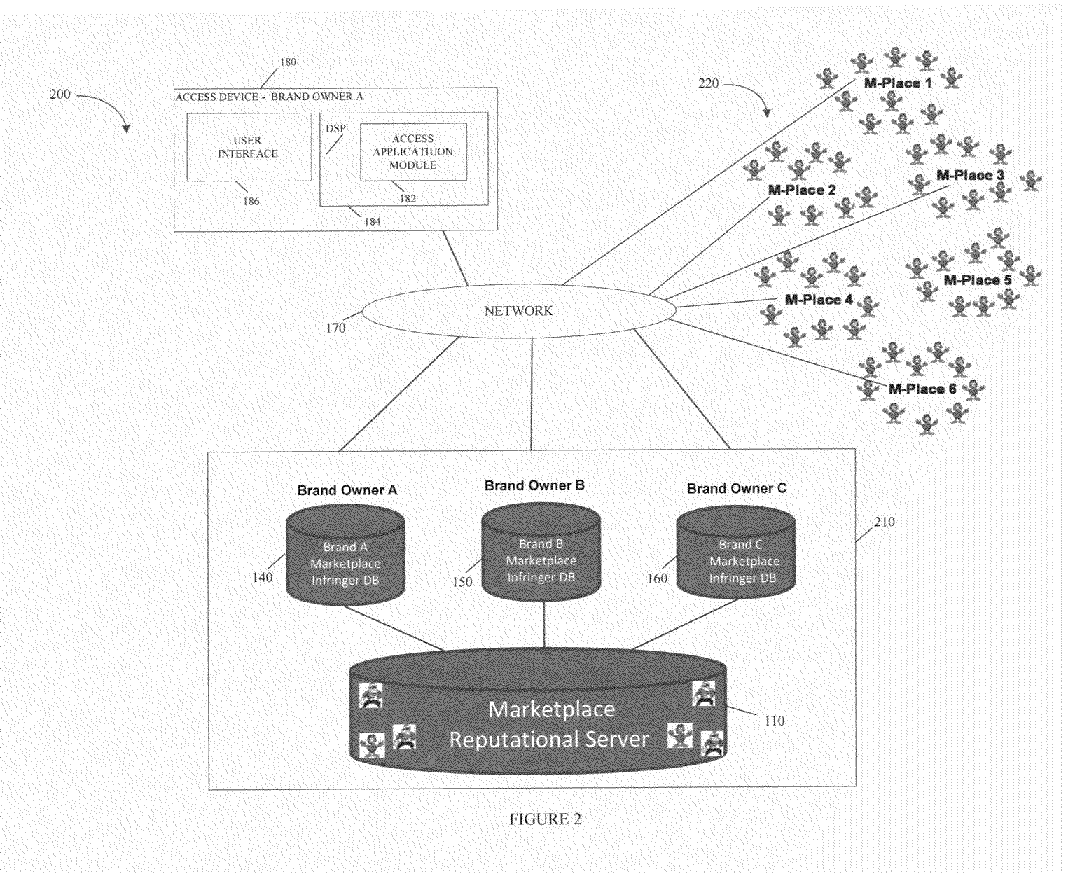

Turning now to FIG. 2, an example of a suitable computing system 200 within which embodiments of the disclosure may be implemented is presented. Specifically, FIG. 2 illustrates one embodiment of the present Inventive system that utilizes a reputational server system 210 that comprises the server device 110 and brand marketplace databases 140, 150, 160 as described in connection with FIG. 1. The reputational server system 210 and the access device 180 of brand owner A are connected to the network 170 as also discussed in connection with FIG. 1. Also connected to the network 170 are marketplaces 220, which are illustrated as M-Place 1, M-Place 2, M-Place 3, M-Place 4, M-Place 5, and M-Place 6. According to one embodiment, marketplaces 220 includes electronic marketplaces or e-marketplaces such as EBAY®, AMAZON®, ALIBABA.COM®, or TAOBAO®.

The computing system 200 is another exemplary embodiment and is not intended to suggest any limitation as to the scope of use or functionality of the disclosure. Neither should the computing system 200 be interpreted as having any dependency or requirement relating to any one or combination of illustrated components. For example, the present disclosure is operational with numerous other general purpose or special purpose computing consumer electronics, network PCs, minicomputers, mainframe computers, laptop computers, as well as distributed computing environments that include any of the above systems or devices, and the like. Other system embodiments of the disclosure may include additional structures that are not shown, such as secondary storage and additional computational devices. In addition, various other embodiments of the disclosure include fewer structures than those shown in FIG. 2.

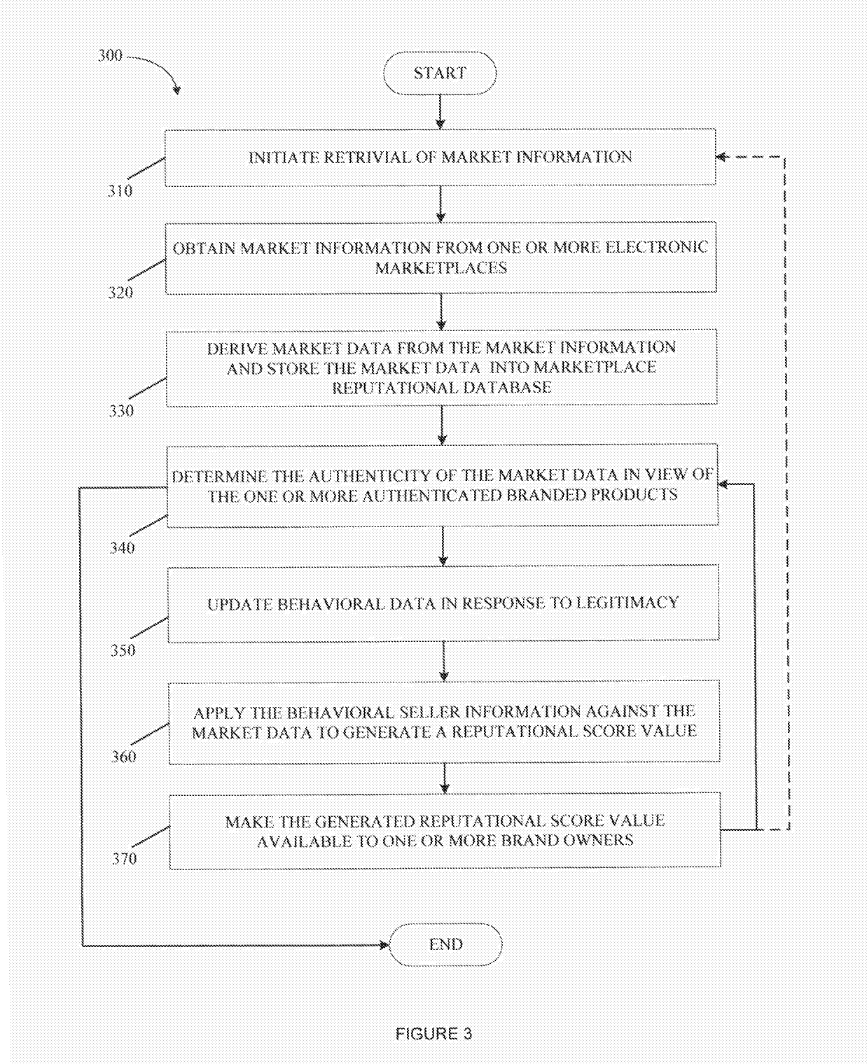

The systems 100 and 200 operate as described with respect to FIGS. 3 through 8.

Turning now to FIG. 3, an exemplary computer-implemented method for evaluating a seller entity in an electronic marketplace offering branded products is disclosed in the context of system 100 and 200 of FIGS. 1 and 2.

At step 310 a retrieval of market information is initiated by the server device 110 depicted in systems 100 and 200 of FIGS. 1 and 2, respectively. At step 320 the market information is obtained or collected from various marketplaces 220. According to one embodiment, referring to FIG. 2, market information, which may include market listing information, seller information, and marketplace information, is retrieved from M-Place 1, M-Place 2, M-Place 3, M-Place 4, and M-Place 6. For example, a listing in an electronic auction for a designer handbag will have associated with it certain market information. In one embodiment, the market listing information, or short listing, can comprise the product being sold, its price, its available quantity, its location, and the marketplace. The seller information can comprise a seller's Id, the seller's location, the seller's name and the seller's contact information. The marketplace information can comprise the marketplace name, the marketplace location, and the marketplace primary contact. Continuing from the previous example, the market listing information would include the make and model of the designer handbag, the sale price, the quantity available, where the designer handbag would be shipped from and the electronic auction website through which the designer handbag is offered for sale. The seller information would include an type of identification associated with the seller, such as the seller's auction website nickname and/or the seller's actual name and the contact information for the seller, such as e-mail address and the marketplace information would include the name and contact information for the auction website.

Referring back to Step 320 of FIG. 3, he approach used to obtain market listing information, also referred to as candidate marketplace listings, seller information, and marketplace information can be achieved through one or more of the following techniques. In one embodiment the search and extraction module 122 uses a marketplace's authorized Application Programming Interface (“API”), which allows a programmatic call to the respective databases of the marketplaces 122 requesting information which would include the market listing information, the seller information, and the marketplace information.

In another embodiment, respective search engines if the marketplaces 122 are leveraged by the search and extraction module 122 to submit search queries in conjunction with a crawling strategy to search for listings. Pre- and post-search screening and filtering techniques as are known in the art may also be used to either include or eliminate search results. The search results returned would include the candidate marketplace listings, which would subsequently be crawled for their detail content after which “screen scraping” techniques, as are known in the art, would be used to identify key information on the candidate listings. This information would leverage Neural Linguistic programming techniques and/or basic extraction capabilities to identify candidate listing information which may be deemed relevant for subsequent review. The information “scraped” would be similar to what is of interest in the API method above with the inclusion but not necessarily limited to the market listing information the seller information, and the marketplace information. Other techniques may be used to identify listings from one or more marketplaces beyond an API or search/scrape approach.

Returning to step 330 of FIG. 3, the market data, also referred to seller-brand data, is derived from the market listing information comprising one or more offered branded products, the seller information comprising the seller entity and activity information, and the marketplace information comprising marketplace identification, is loaded to and stored in the market data store 132. Use collected market data is then normalized across all marketplaces such that the structured and/or unstructured data that is obtained in step 320 is stored in the market data store 132 with a list of attributes which are warehoused into the centralized repository. In addition to storing this information into market data store 132, the market data is also collected and stored into the respective brand owner market databases 140, 150, and 160. In one embodiment, the market data comprises data elements associated with the listing that was acquired, which would include attributes such as: seller ID, seller name, seller location, product(s) sold in listing, brand(s) identified in listing, listing ID, marketplace name; brand owner requesting listing, brand owner product being requested, product cost, product quantity sold in listing and listing location.

At step 340, the market data obtained is analyzed in order to determine the authenticity or legitimacy of the offer for sale of the subject product in view of one or more authenticated branded products. According to one embodiment, the market data is used to identify the legitimacy of a product or brand being sold. This review process is primarily performed automatically. Historical review processes may be used as part of the machine learning such that future listings may be electronically identified and flagged for its legitimacy. In one embodiment, certain key markers contained in the market data are identified, which is subsequently used to generate an electronic score that, identifies the confidence levels of legitimacy of products being sold and can. be used to set a threshold for allowing automated review and execution of listings. Examples of markers identified and reviewed electronically may be for example the combination of:

Price×Quantity

where the Price for the product being offered drops below a specified threshold of Minimum Advertised Price by the brand owner such as 30% lower than the Minimum Advertised Price with a quantity of 30. This combination would create an automated trigger that identified it as highly confident of being considered counterfeit. These types of rules could be defined or derived based on either preset descriptions or automated machine learning over time. The example is not an exhaustive approach and other means may include additional attributes like

Price×Quantity×Number

of listings by seller entity of the same product. A further example to be identified and reviewed can be

Marketplace Listing Location×Seller ID

which may have been implicated in prior reviews or investigations. The mentioned examples should not be viewed as an exhaustive approach as to how the collected market data would be used to electronically score and create a confidence level as to an automated review process.

An Individual review would allow doing interrogation of the attributes collected and stored in the data store 130 such that expertise and knowledge obtained through years of experience would allow the individual to determine the likelihood of legitimacy of goods being sold. The information reviewed could be either subjective or objective based on many factors and would be a collection of information that is determined and gathered through investigative and review methods that are used based on experience and Interaction with a brand owner entity and the brand owners “tolerance” on accuracy thresholds for legitimacy. During the individual review operation information from the above process step may be leveraged used in part or in whole to assist in the individual review process. The information from the individual review may also be leveraged through machine learning such that the algorithms are adjusted or new algorithms are created which would potentially facilitate future reviews more efficient.

At step 350 behavioral data is updated in the behavioral data store 134 of the data repository 130 in response to an authentication of the reviewed offered branded products. The behavioral data comprises brand owner claim information, marketplace determination information or combination thereof. The update of the behavioral data would facilitate the creation of additional attributes in the behavioral data store 134 including: listing legitimacy determination, date reviewed, brand owners decision, marketplace determination, listing takedown status, time taken for removal repeat infringer, additional seller identification, number of times seller requested for removal, etc. In response to the prior step 340, associated with the review process, the resulting information is then stored in one or more of the brand marketplace database servers 140, 150, 160 as well as the behavioral data store 134 providing key insight and relevant as well as useful information as to the legitimacy of the listings, the sellers, and the products being sold. This information is to be considered as relevant artifacts for future use. The collected information and artifacts from the reviewed results would indicate the correlation of one or more of market listing information, seller information, brand owner information, review or enforcement decision information.

The collected information is relevant to the method and can then be subsequently used in all phases including and not limited to step 320 “Obtaining listing”, step 330 “Storing Data”, and/or step 340 “Reviewing Listing information” as described above.

At step 360 at least one reputational score value is generated through combining the behavioral data and the market data. The at least one reputational score value is indicative of the evaluation of the seller entity. More precisely, the behavioral data that comprises behavioral seller information is applied against the market data with listing information to derive reputational score, values including brand owner reputation values, marketplace seller reputation values, and marketplace reputation values, which are stored in the reputational scores data store 136. The information collected and updated in the prior step 350 can be used in an automated fashion to dynamically create multiple reputational scores or score values associated with listings, seller entities, marketplaces, brand owner entities for creating a behavioral model across the marketplace ecosystem or community. The information in the reputational scores data store 136 would contain information which may be leveraged either for a specific listing, seller and brand combination or across multiple instances and may then be used as part of a scoring or score value computation which would then be used to rate reputations of seller entities, marketplaces, and brand owner entities. Examples, but not an exhaustive list or method for calculation, for each can be as follows:

### Setters Reputation Calculation=Seller ID×# Brand Owner Claims×Successful Uncontested Marketplace Takedowns of Listings.

Marketplace Reputation=# Sellers×# Repeat Enforcements against Sellers×#Times Seller allowed to continue to sell.
Brand Owner Reputation=# Enforcements Submitted×# False claim Reports by Seller×Brand Owner Uncontesting.

It should be understood that there might he more than one reputational score value for each of the above types and various approaches is calculated. This is because each seller entity, marketplace, and brand owner entity may have multiple and various reputations for their respective activities or behaviors. These multiple reputational calculations may then be combined or used individually to make future determinations.

At step 370 the at least one score value or multiple score values are made available and can be provided to brand owner entities or other interested entities. These entities can then apply the reputational score values and other information for subsequent scans of their brands. The information and data obtained throughout the prior steps and stages can be leveraged so that reputational score values are applied and considered for future searches in obtaining listings, the storage of that information, review/validation, and subsequent rescoring. This creates a closed loop environment, as indicated with the process flow returning to step 340, such that the information can be leveraged in the identification of listings that are flagged for legitimacy, seller or seller entities that are identified as legitimate for not only the originating brand owner that identified the seller in the first place but more importantly leveraging the information for future brands as to the legitimacy of listings×sellers that may also be representing a different brand owner or entity. In another embodiment, process flow continues to step 310 as depicted by the dotted line as depicted in FIG. 3, which illustrates that seller reputational information consisting of seller ID, marketplace ID, and one or more reputation score values could be used to initiate a query to each of the marketplaces 220 requesting snatching sellers that have listings selling one or more brands. The data with the information and score values may also be used by marketplaces for authorization and or pre-screening, by brand owners for identifying infringers, by possible resellers, and for identifying brand owners that may be overstepping their boundaries in aggressive enforcement techniques. The reputational information with the reputational score values and ongoing dynamic scoring are a relevant component in the method and ecosystem of marketplace×seller entity×listing×brand owner ecosystem.

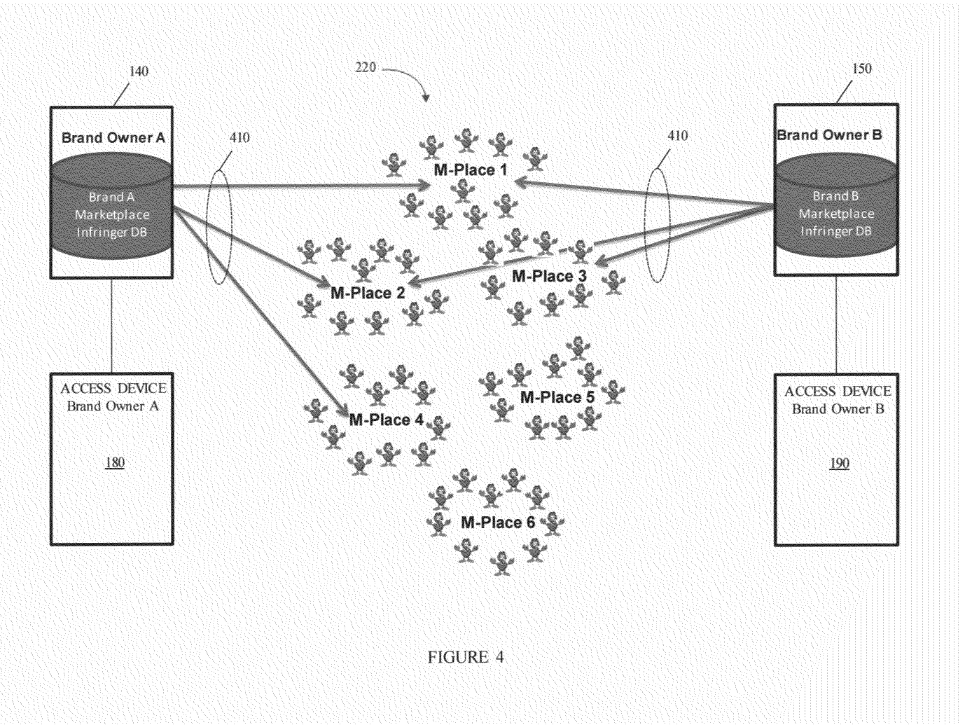

In the following FIGS. 4 to the steps of the method 300 are illustrated in more detail.

Turning now to FIG, 4 that, corresponds to step 310 and illustrates, in one embodiment, brand owner A and B initiating through their access devices 180 and 190 and the respective brand marketplace database servers 140 and 150. search requests 410 to marketplaces 220 and asking for all listings selling branded products. In the example brand owner A requests information from M-Place 1, M-Place 2, and M-Place 4, whereas brand owner B requests information from M-Place 1, M-Place 2, and M-Place 3, FIG. 4 represents a first step in initiating the retrieval of, for example, seller IDs, which a brand owner makes the request by searching for listings on marketplaces 220 that, contain their brand. The marketplace request 410 is for listings or sellers. Use seller information is collected from the listing information and a seller can have many listings on the marketplace returning many results per seller. At this point, the marketplace 220, e.g. M-Place 1, has no knowledge that an individual seller is potentially doing a criminal activity as being a counterfeiter or infringer. Such information is not known to the marketplace and not captured.

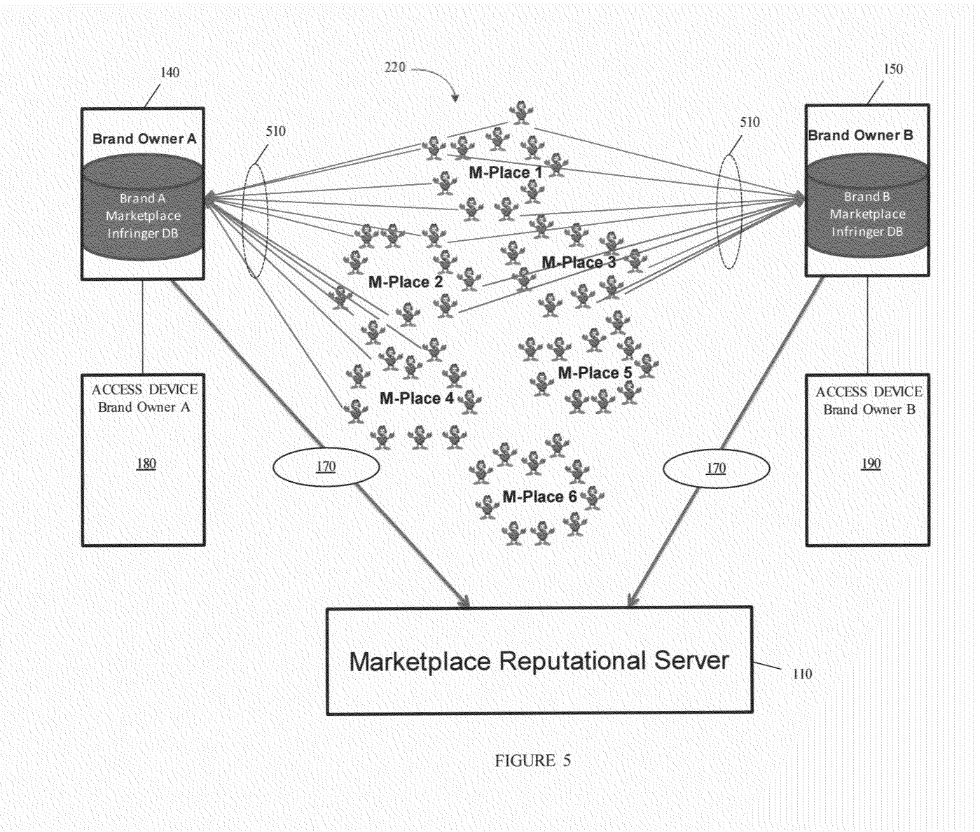

FIG. 5 corresponds to step 320 and illustrates, in one embodiment, the extraction of market listing information from one or more seller entities at one or more of the marketplaces 220, The marketplace search requests 410 return results 510 of listings via the network 170 from one or more of the marketplaces 220 to the respective brand database server 140 and 150 and the marketplace reputational server 110. Subsequently, seller information, brand information, and marketplace information is derived by the marketplace reputational server 110 and loaded into the data repository 130. FIG. 5 represents the ability to extract relevant information from brand owners taking discrete listing information and capturing seller and brand attributes and subsequently (i) adding and or changing information and (ii) deriving additional information that is then deduced and stored into the market data store 132 of the marketplace reputational server 110. Various capabilities and techniques can be used in verifying the pre-existence of a seller in the data store, the additional attributes such as the brand owner identity that is reporting the seller ID, and the ability to store additional information on the seller including any informational changes or updates.

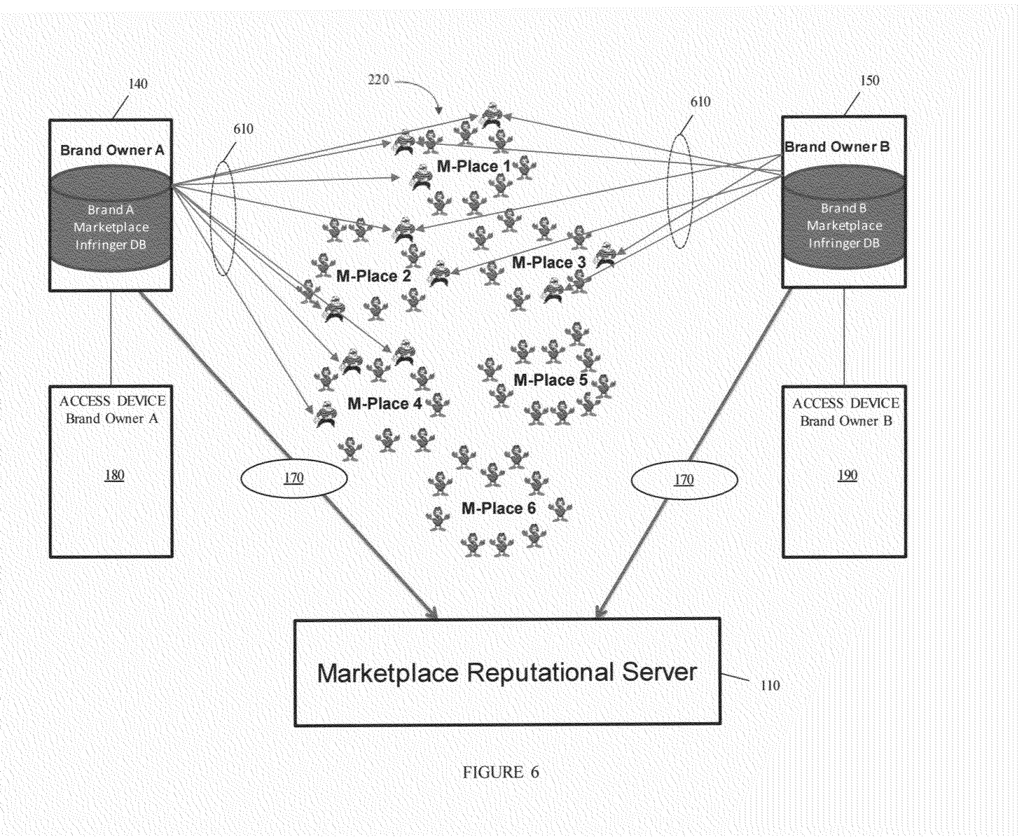

FIG. 6 corresponds to step 340 and represents, in one embodiment, the collecting of additional information by request 610 once the brand owner has determined and verified which listings represent a potential infringement on their brand, as well as a potential reason code that can be used for enforcement purposes. Potential reason codes, e.g., “trademark violation”, “counterfeit product” or “product never produced”, are created by the marketplace, but usually are different from marketplace to marketplace. The offered branded products are authenticated and the information is captured and derived such that informational updates on sellers that were found on the listing itself are updated as behavioral data and stored in the behavioral data store 134 of the marketplace reputational server 110. For example, information is captured wherein the brand owner believes its brand was infringed and that the associated seller should be identified as an infringer. The captured information is stored in the behavioral data store 134 and the subsequent, scoring to determine the reputational score values is executed, adjusting the score value of a particular seller that is having their information updated.

For example, the brand owner A makes a claim to the marketplace M-Place 1 that this listing and seller is infringing on its rights or distributing its products illegally or trafficking in counterfeit goods. Nevertheless, not all listings retrieved are considered by brand owner A to be infringing. As indicated above, additional information is stored in the behavioral data store 134 indicating that the brand owner A believes the seller is infringing on their brand but there is no indication as to whether the infringer has been considered by the marketplace M-Place 1 as doing criminal activity. At this point sellers or seller entities are accused as doing criminal activity and thus these are marked accordingly as potential infringers. It should be noted that the inverse might be true, A seller within a marketplace may be found to be conducting legitimate selling activities, which would be considered non-infringing. The artifacts consisting of non-infringing behavioral information and any subsequent scoring may still be captured, computed and stored in the behavioral data store 134.

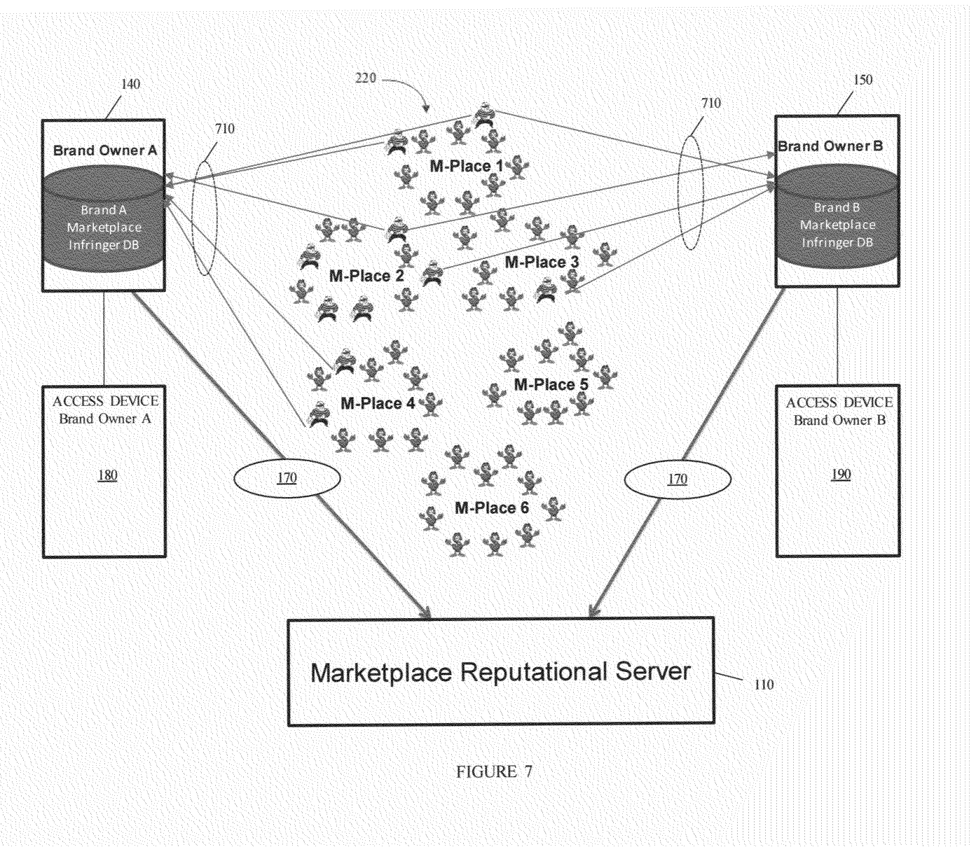

FIG. 7 corresponds to step 350 and represents, in one embodiment, either an

acknowledgement or rejection notification 710 by the marketplaces 220 as to whether the listing is in violation or in compliance with their rules. Further information from these notifications 710 is then derived and extracted such that seller information along with reason codes or acknowledgement can be stored as behavioral facts, also referred to as behavioral data, against or for a seller or seller entity. This behavioral data comprises a lookup and is constantly updated with the respective seller data as well as potential proprietary derived reputational score values as a result of the recently reported behavior. The marketplace 220 either removes a listing or keeps the listing posted after determining if a brand owner claim is valid. All the information Is captured in the data repository 130 regardless of whether the marketplace 220 deems them to be enforceable or not. From a marketplace perspective sellers at this point are agreed by the marketplace 220 to have infringed and agreed to as doing criminal activity so are marked as confirmed infringers, however some marketplaces may keep some sellers active and do not view or track them as criminals.

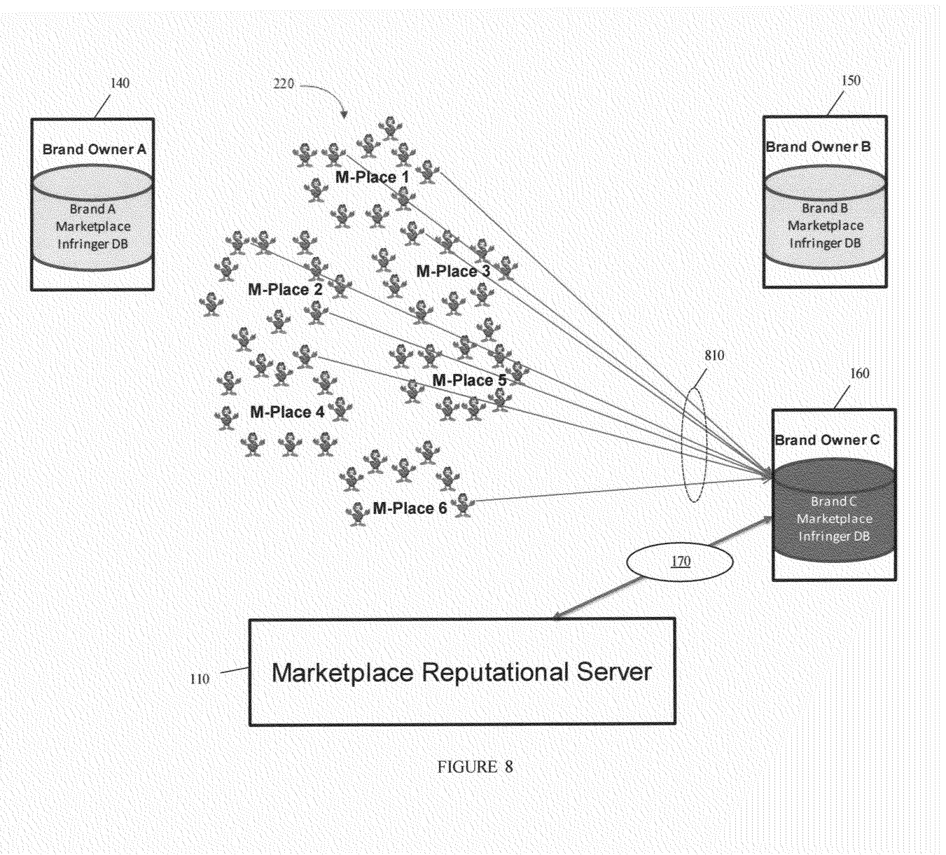

FIG. 8 represents, according to one embodiment, what occurs when a new brand owner C with the band C marketplace database server 160 is added to the systems 100 and 200. In this case, brand owner C's search results 810 and the resulting listings with extracted seller IDs from these listings are taken to the marketplace reputational server 110 via the network 170. A search by the brand C marketplace database server 160 through the network 170 is performed at the marketplace reputational server 110. The results 810 that correspond to step 320 are checked against the behavioral-data store 134 to identify prior infringers regardless of whether it was an infringement specifically identified from the brand owner C, i.e. a known seller with prior infringement history on the marketplace 220. The information of known prior brand infringers is delivered with one or more reputational score values allowing brand owners A, B and C to prioritize on the respective enforcement strategy. All the steps described in connection with FIGS. 4 through 7 are performed with the additional step of added information pertaining to a particular seller or seller entity being returned along with additional fields from the database 130 enhancing the data the brand owner C store. These fields can comprise information to reputational score values, seller type indication (e.g., legitimate brand seller, counterfeit brand seller and rogue distributor), as well as additional Information such as the location of the seller. prior number infringements against brand owners, other marketplaces that the seller may be selling on and the industry/product type that the seller typically operates in.

The types of attributes and information that are stored in the reputational data repository 130 and processed by the marketplace reputational server 110 serve as example and are not a definitive list of attributes which may be acquired or derived from the various sources, in addition, the sellers in the database may show interconnection between the marketplaces and show linkages of sellers which are computationally derivable based on a variety of attributes.

According to one embodiment, attributes that are captured in the data repository 130 and are derived by the servers 110 and 210 include reputational score values, seller ID, seller location, infringing industry type, successful enforcements, unsuccessful enforcements, etc.

The data and information of the marketplace reputational server 110 can be used in enforcement by other brand owners, by marketplaces to blacklist sellers, by payment processors, by marketers for expanding channels, by government agencies for tax recovery and other purposes as is known in the art.

FIGS. 1 through 8 are conceptual illustrations allowing for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated, blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium/” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of Interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, the applicants do not intend for any term in the specification or claims to be ascribed an uncommon or special meaning unless explicitly set forth as such. Further, the present disclosure encompasses present, and future known equivalents to the known components referred to herein by way of illustration.

The foregoing description of the specific embodiments so fully reveals the general nature of the disclosure that others can, by applying knowledge within the skill of the relevant art(s), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not as limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for evaluating a seller entity in an electronic marketplace offering products related to a brand owner entity comprising:
obtaining, by at least one specialized computer system, market information from one or more electronic marketplaces, the market information comprising market listing information comprising one or more offered branded products, seller information comprising seller entity and activity information, and marketplace information comprising marketplace identification;
deriving market data form one or more of the market listing information, the seller information and the marketplace information;
storing in a non-transient memory the derived market data;
determining, by the at least one specialized computer system, the authenticity of the market data in view of the one or more authenticated branded products;
updating the non-transient memory with behavioral data in response to an authentication of the market data, wherein said behavioral data comprises one or more of brand owner claim information and marketplace determination information; and
generating, by the at least one specialized computer system, at least one reputational score value, wherein said generating comprises combining the behavioral data and the market data, wherein said at least one reputational score value is indicative of the evaluation of the seller entity.

2. The computer-implemented method of claim l. wherein obtaining, by at least one specialized computer system, market information from one or more electronic marketplaces further comprises using one or more reputational score values to search the electronic marketplace for the one or more offered branded products.

3. The computer-implemented method of claim 1, wherein updating the non-transient memory with behavioral data in response to an authentication of the market data further comprises verifying whether at least one or more reputational score values are known.

4. The computer-implemented method of claim 1 further comprising making the at least one reputational score value available, to one or more brand owner entities.

5. The computer-Implemented method of claim 1, wherein determining, by the at least one specialized computer system, the authenticity of the market data in view of the one or more authenticated branded products further comprises identifying a potential infringement.

6. The computer-implemented method of claim 1, wherein the at least one reputational score value identifies, the behavior of the seller entity in one or more electronic marketplaces.

7. The computer-implemented method of claim 1, wherein the at least one reputational score value identifies whether the seller entity offers counterfeited products.

8. The computer-implemented method of claim 1, wherein the at least one reputational score value identifies the seller entity as being a potential distributor for one or more brand owner entities.

9. The computer-implemented method of claim 1 further comprising using the at least one reputational score value to identify a seller entity as a negative entity.

10. The computer-implemented method of claim 1, wherein the at least one reputational. score value is applied by the electronic marketplace to pre-screen and preauthorized selling activities of the seller entity in said electronic marketplace.

11. The computer-implemented method of claim 1, wherein the at least one reputational score value is applied by the electronic marketplace to predict a potential seller entity that is identified for further investigation by government agencies or brand owner entities.

12. The computer-implemented method of claim 1, wherein the at least, one reputational score value is applied by the electronic marketplace to identify money-laundering activities.

13. The computer implemented method of claim L wherein the at least one reputational score value is used by a payment processor to determine a payment risk of the seller entity.

14. The computer implemented method of claim 1, wherein based on historic market data, the seller entity is identified to be monitored by one or more brand owner entities for facilitating rapid identification and removal of online listings.

15. The computer implemented method of claim 1, wherein a group of brand owner entities identify multiple seller entities based on product type and one or more reputational score values.

16. The computer implemented method, of claim 1, wherein a seller entity group is identified based on selling behavior and commonalities between seller entities and their market listings.

17. The computer implemented method of claim 1, wherein the seller entity is identified as a legitimate seller entity by a product classification associated with selling activities across similar product classifications.

18. Non-transitory computer readable media comprising program code stored thereon for execution by a programmable processor to perform a method for evaluating a seller entity in an electronic marketplace offering products related to a brand owner entity, the computer readable media comprising:
program code for obtaining market information from one or more electronic marketplaces, the market information comprising market, listing information comprising one or more offered branded products, seller information comprising seller entity and activity information, and marketplace information comprising marketplace identification;
program code for deriving market data form one or more of the market listing information, the seller information and the marketplace information;
program code for storing in a non-transient memory the derived market data; program code for determining the authenticity of the market data in view of the one or more authenticated branded products;
program code for updating the non-transient memory with behavioral data in response to an authentication of the market data, wherein said behavioral data comprises one or more of brand owner claim information and marketplace determination information;
program code for generating at least one reputational scorn value, wherein said generating comprises combining the behavioral data and the market data, wherein said at least one reputational score value is indicative of the evaluation of the seller entity; and
program code for storing the at least one reputational score value in the non-transient memory.

19. A system for evaluating a seller entity in an electronic marketplace offering products related to a brand owner entity, the system comprising;
a non-transient memory; and
a server including a processor configured to;
obtain market information from one or more electronic marketplaces, the market information comprising market listing information comprising one or more offered branded products, seller information comprising seller entity and activity information, and marketplace information comprising marketplace identification;
derive market data form one or more of the market listing information, the seller information and the marketplace information;
store in the non-transient memory the derived market data;
determine, by the at least one specialized computer system, the authenticity of the market data in view of the one or more authenticated branded products;
update the non-transient memory with behavioral data in response to an authentication of the market data, wherein said behavioral data comprises one or more of brand owner claim information and marketplace determination information;
generate at least one reputational score value, wherein said generating comprises combining the behavioral data and the market dam, wherein said at least one reputational score value is indicative of the evaluation of the seller entity; and
store the at least one reputational score value in the non-transient memory.

20. The system of claim 19 configured to provide the at least one reputational score value to one or more brand, owner entities.
